(19) United States
(12) Patent Application Publication
(10) Pub. No.: US 2010/0332122 A1
(43) Pub. Date: Dec. 30, 2010

(54) ADVANCE AUTOMATIC FLIGHT PLANNING USING RECEIVER AUTONOMOUS INTEGRITY MONITORING (RAIM) OUTAGE PREDICTION

(75) Inventors: Shimon WEICHBROD, Baltimore, MD (US); Monte L. Bolt, JR., Dunkirk, MD (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/694,589

(22) Filed: Jan. 27, 2010

Related U.S. Application Data
(60) Provisional application No. 61/219,975, filed on Jun. 24, 2009.

(51) Int. Cl. G01C 21/00; G01S 19/01

(52) U.S. Cl. 701/202

(57) ABSTRACT

A method for generating a flight plan for a user's aircraft using Receiver Autonomous Integrity Monitoring (RAIM) outage information is disclosed. The method may include receiving a flight plan request from the user, obtaining RAIM outage information, comparing the requested flight plan against the obtained RAIM outage information, determining if any RAIM outages contained in the RAIM outage information affect the requested flight plan, wherein if it is determined that any RAIM outages affect the requested flight plan, generating one or more flight plan options based on the determined RAIM outages, prompting the user to select at least one of the one or more generated flight plan options, receiving the user's one or more selections, generating a modified flight plan based on the user's one or more selections, and outputting the modified flight plan to the user and storing the modified flight plan in a flight plan database.

### PRIORITY INFORMATION

This non-provisional application claims priority from U.S. Provisional Application Ser. No. 61/219,975, filed, Jun. 24, 2009, the content of which priority is incorporated herein by reference in it entirety.

### BACKGROUND OF THE DISCLOSED EMBODIMENTS

1. Field of the Disclosed Embodiments

The disclosed embodiments relates to aircraft flight planning systems.

2. Introduction

In conventional flight operations, Global Positioning Systems (GPS) serve as a primary source of navigation for aircraft (and other vehicles, watercraft, individuals, etc.) in the world today. From time to time, the number of required acurate GPS satelittes that may be available in a particular time and/or area may be less than needed to ensure safety-of-flight. If an aircraft relies solely on an external navigation source such as a GPS for navigation, the aircraft may be flying without any accurate navigation source which may create a serious hazard to that aircraft and others it may encounter in the same airspace.

The Federal Aviation Administration (FAA) will soon be requiring that all aircraft that rely solely on a Global Positioning System (GPS) or other external naviagtion sources to determine Receiver Autonomous Integrity Monitoring (RAIM) outages prior to their departure. RAIM is a system that informs a pilot when he or she will lose accurate external navigation service coverage during a flight based on a filed flight plan. While the pilot or other designated crew member will know when the external navigation outages will occur, there is currently no system available that will provide the information necessary to allow the pilot to choose to alter his or her flight plan inputs (departure time, arrival time, route, airspeed, etc.) before flight or enroute based on the known external navigation outages.

### SUMMARY OF THE DISCLOSURE

A method for generating a flight plan for a user's aircraft using Receiver Autonomous Integrity Monitoring (RAIM) outage information is disclosed. The method may include receiving a flight plan request from the user, the flight plan request including at least aircraft identification information, aircraft type, true airspeed, departure point, departure time, cruising attitude, route of flight, destination, estimated time in-route, and fuel on board, obtaining RAIM outage information, the RAIM outage information including at least predicted times and locations along a route of flight that an aircraft will lose accurate external navigation service coverage during a flight based on the requested flight plan, comparing the requested flight plan against the obtained RAIM outage information, determining if any RAIM outages contained in the RAIM outage information affect the requested flight plan, wherein if it is determined that any RAIM outages affect the requested flight plan, generating one or more flight plan options based on the determined RAIM outages, prompting the user to select at least one of the one or more generated flight plan options, the one or more generated flight plan options being at least one of a change in departure time, destination, stopovers, route of flight, altitude, and airspeed, receiving the user's one or more selections, generating a modified flight plan based on the user's one or more selections, and outputting the modified flight plan to the user and storing the modified flight plan in a flight plan database.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is diagram of an exemplary flight planning environment in accordance with a possible embodiment of the disclosure;

FIG. 2 is a block diagram of an exemplary flight planning system in accordance with a possible embodiment of the disclosure;

FIG. 3 is an exemplary flowchart illustrating one possible flight planning process using RAIM outage information in accordance with one possible embodiment of the disclosure;

FIG. 4 is an exemplary flowchart illustrating one possible in-flight planning process using RAIM outage information in accordance with a possible embodiment of the disclosure; and

FIG. 5 is an illustration of RAIM outage information concerning one possible aircraft flight plan in accordance with a possible embodiment of the disclosure.

### DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments will become more fully apparent from the following description and appended claims, or may be learned by the practice of the disclosed embodiments as set forth herein.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments. Note that while this disclosure discusses aircraft and airline uses for the disclosed embodiments, the disclosed embodiments by no means limited to that area and may be applied to a wide variety of environment and uses.

The proposed disclosed system and method concerns a system and method that may provide a pilot, flight crew, system, agency, etc. (hereinafter “a user”) with detailed information about RAIM outages and flight plan modification options. In this manner, the user may be provided with RAIM outage information along a requested or in-flight route of flight shown by time and points in-route a timeline for his/her expected departure time along with a selection of windows of possible departure times before and after or the expected departure time in order to avoid RAIM outages. The user may then select his/her departure time with no expected RAIM outages and still meet the FAA's RAIM requirements. The disclosed embodiments may also concern a method and apparatus that automatically avoids RAIM outages and calculates and determines the best route of flight that meets RAIM requirements and allows the user to choose a departure or arrival at a specific time or a specific route, in order to meet passenger, cargo, etc. requirements.

A RAIM outage prediction unit may be used to calculate the RAIM outages based on the requested flight plan input by a user and the obtained external navigation (e.g., GPS) outages and present them to a the user (e.g., pilot or flight crew member, etc.) in a variety of manners, such as hard copy, text message, e-mail, electronic transmission, Electronic Flight Bag (EFB) input, etc. The RAIM outage prediction unit may be located within or cooperate with a flight planning system and may operate in conjuction with or separate from other safety-of-flight processes and products, for example.

In addition, the RAIM outage prediction unit may provide an aircraft with updated RAIM outage information in-flight. For example, while in-flight, a pilot may have to change his or her flight plan while in-route based on weather or other circumstances. The RAIM outage prediction unit may send an RAIM outage report or options to the aircraft in-flight or enroute via any known communication method, such as data link, ACARS, radio, e-mail, text, electronic transmission, upload to the EFB, etc. In this manner, the pilot may suggest to air traffic control to alter the aircraft's route, airspeed, times, etc. concerned with the revised flight plan. The RAIM outage information may also provide the pilot with a confirmation once the primary (e.g., GPS) navigation system goes offline in-flight. The pilot can check the electronic or paper RAIM outage report to confirm that the GPS system problems were a scheduled event and when to expect the GPS services to come back on-line. The pilot may switch to an alternative navigation system (if available), such as using an inertial navigation system, for example.

The RAIM outage prediction unit may also provide the pilot with multiple options, altitudes, waypoints, routes, speeds, etc. as choices to avoid GPS outages. Thus, these options may provide the pilot great flexibility by offering several alternatives in order to choose the manner in which the aircraft will avoid losing accurate GPS services.

The RAIM outage unit may also be combined with other flight planning tools, weather, meterological, aviation and safety-of flight information. Such weather, meterological, aviation and safety-of flight that may be received from safety-of-flight servers and may be considered by the RAIM outage prediction unit when outputting RAIM outage information and recommended route information to pilots and may also include aircraft performance data, winds aloft, navigation data, restricted areas, radar, lightning reports, clear air turbulence reports, NOTAMs, SIGMETs, AIRMETs, wind shear reports, etc.

In this manner, a flight plan may be run through any type of vector or latitude/longitude-based images that can be rendered in a way that a flight planning system can utilize the information. The flight plan may be take in account the GPS outage information along with weather, metrological data, and safety of flight information for a 360 degree horizontal layer at all relevant altitudes and times. This information may include forecasted data, real time/real world information or any combination thereof.

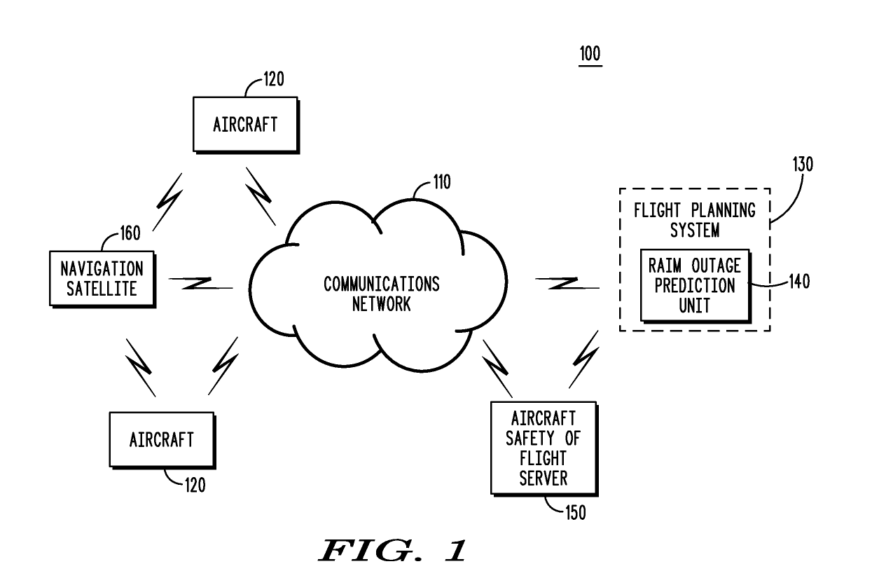

FIG. 1 is diagram of an exemplary flight planning environment 100 in accordance with a possible embodiment of the disclosure. The flight planning environment 100 may include one or more aircraft 120, a flight planning system 130, and one or more aircraft safety of flight servers 150 connected through the communications network 110. The flight planning system 130 may also include a RAIM outage prediction unit 140. Alternatively, the RAIM outage prediction unit 140 may be a stand alone unit connected to the flight planning system 130.

Aircraft 120 may represent any airborne object manned or unmanned that may rely on external navigation sources, such as commercial aircraft, cargo aircraft, military aircraft, helicopters, other rotary wing aircraft, blimps, NASA aircraft or spacecraft, Unmanned Aerial Vehicles (UAVs), etc. Navigation satellite 160 may represent any space or airborne navigation source (such as a GPS source) from which aircraft receive navigation signals and information in order to identify its own location, the location of other aircraft, the location of aircraft-related navigation aids, the location of airports and landing strips, etc. The navigation satellite 160 may also provide other useful aviation-related information, such as time, heading, speed, altitude, etc. to the aircraft 120.

The one or more aircraft safety of flight servers 150 may be connected to one or more document/message sources which may then be connected to one or more document/message source databases in order to obtain safety of flight information, such as RAIM outage information. Although the connections in FIG. 1 are shown as a wireless configuration, in some cases, one or more of these connections may also be wired in any manner known to those of skill in the art.

Communications network 110 may represent any communications network used to communicate with other entities, including the Internet, an intranet, a radio network, a wireless network, etc. The flight planning system 130 may be any server, computer, processing device, personal digital assistant (PDA), or other similar device capable of processing safety of flight and other aviation-related information in order to generate flight plans and provide flight planning information and options to pilots and flight crews of one or more aircraft 120.

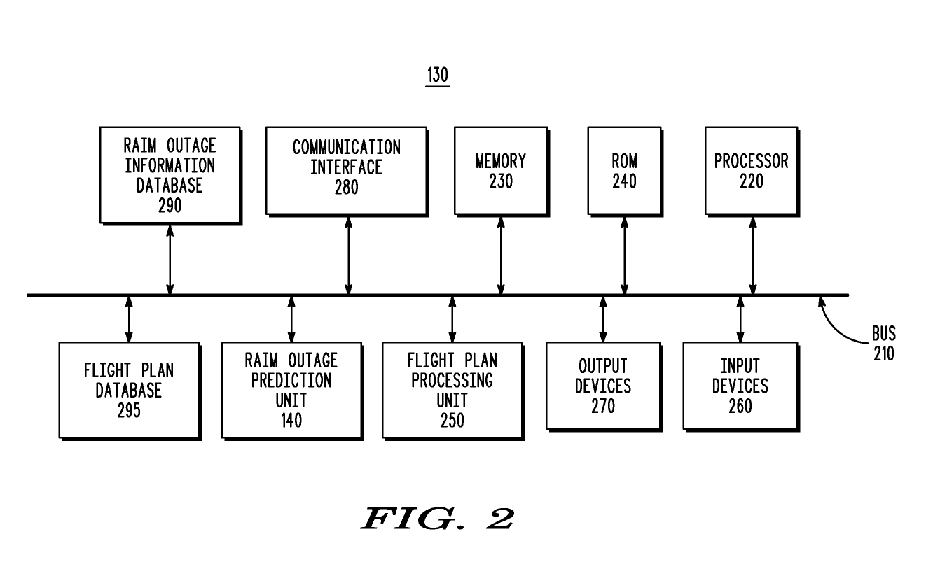

FIG. 2 is a block diagram of an exemplary flight planning system 130 in accordance with a possible embodiment of the disclosure. The exemplary flight planning system 130 may include bus 210, processor 220, memory 230, read only memory (ROM) 240, flight plan processing unit 250, RAIM outage prediction unit 140, input devices 260, output devices 270, communication interface 280, RAIM outage information database 290, and flight plan database 295. Bus 210 may permit communication among the components of the flight planning system 130.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any storage device that may include any type of media, such as, for example, magnetic or optical recording media and its corresponding drive.

Input devices 260 may include one or more conventional mechanisms that permit a user to input information to the flight planning system 130, such as a keyboard, a mouse, a pen, a voice recognition device, etc. Output devices 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the flight planning system 130 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the flight planning system 130, communication interface 280 may not be included in the exemplary flight planning system 130 when the flight planning process is implemented completely within the flight planning system 130.

The flight plan database 290 may contain any filed flight plan, such as fight plans that may be active, pending, approved, expired, archived, etc. Individual flight plans or groups of flight plan may be recalled in order to check the flight plans against and new, existing, or updated RAIM outages.

The RAIM outage information database 290 may serve to store messages, up-to-date media publications, etc. received from one or more safety of flight servers 150 or other aviation-related input services having information pertaining to external navigation service outages, for example. Note that both or either of the RAIM outage information database 290 and the flight plan database 295 may be stored in the memory 230, for example.

The flight planning system 130 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The flight planning system 130 illustrated in FIGS. 1 and 2 and the related discussion are intended to provide a brief, general description of a suitable computing environment in which the disclosure may be implemented. Although not required, the disclosure will be described, at least in part, in the general context of computer-executable instructions, such as program modules, being executed by the flight planning system 130, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

For illustrative purposes, the operation of the flight plan processing unit 250, the RAIM outage prediction unit 140, and the flight planning process will be described below in relation to the block diagrams shown in FIGS. 1-2.

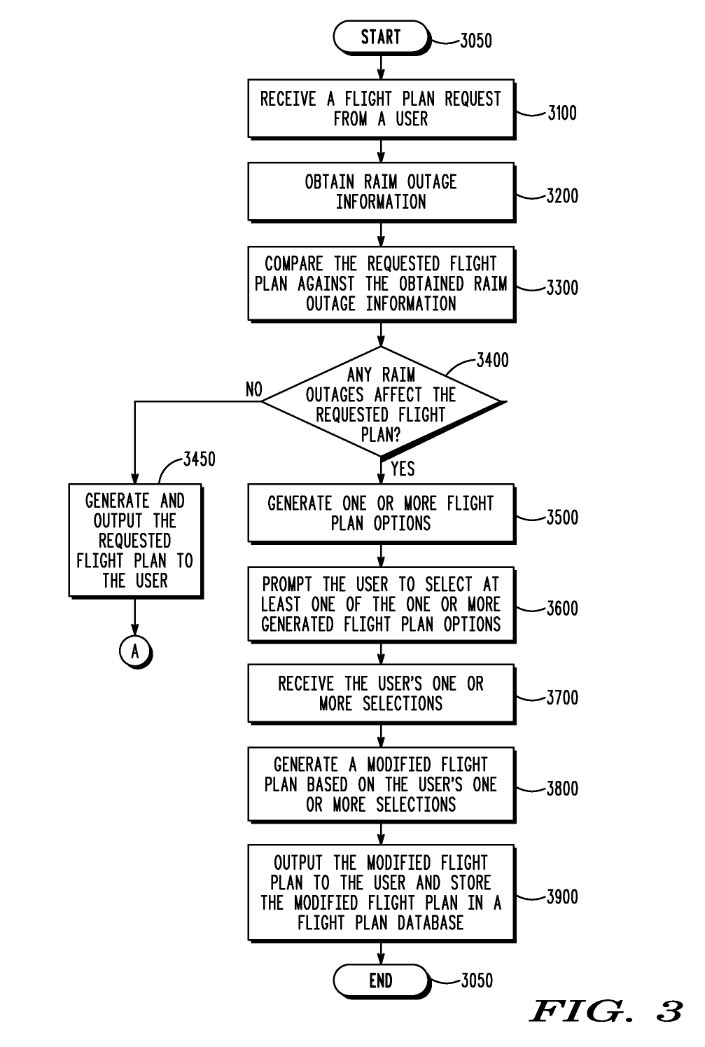

FIG. 3 is an exemplary flowchart illustrating one possible flight planning process using RAIM outage information in accordance with one possible embodiment of the disclosure. The process may begin at step 3050 and may continue to step 3100 where the RAIM outage prediction unit 140 may receive a flight plan request from the user. The flight plan request may include aircraft identification information, aircraft type, true airspeed, departure point, departure time, cruising attitude, route of flight, destination, estimated time in-route, fuel on board, etc., for example.

At step 3200, the RAIM outage prediction unit 140 may obtain RAIM outage information. The RAIM outage information may include predicted times and locations along a route of flight that an aircraft will lose accurate external navigation service coverage during a flight based on the requested flight plan, for example. The RAIM outage information may be obtained from a RAIM outage information database 290 stored in memory 230, a safety of flight server 150, or a combination thereof, for example.

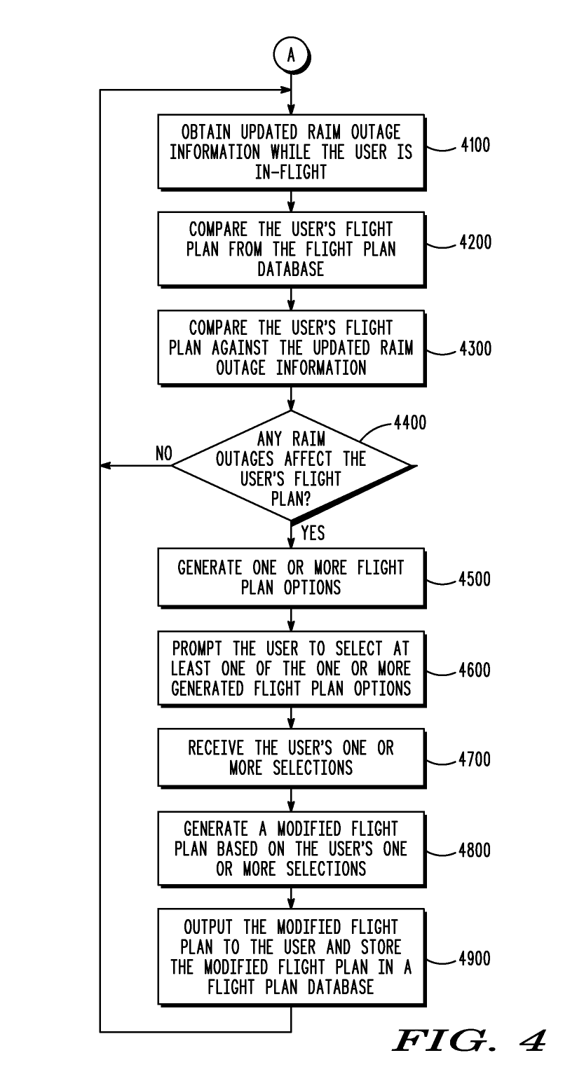

At step 3300, the RAIM outage prediction unit 140 may compare the requested flight plan against the obtained RAIM outage information. At step 3400, the RAIM outage prediction unit 140 may determine if any RAIM outages contained in the RAIM outage information affect the requested flight plan. If the RAIM outage prediction unit 140 determines that there are no RAIM outages that affect the requested flight plan, the process may go to step 3450 where the flight plan processing unit 140 may generate and output the requested flight plan to the user. The generated flight plan may be stored in a flight plan database 295, for example. The process may then go to an in-flight RAIM outage monitoring process “A” which is shown in and described in relation to FIG. 4.

If the RAIM outage prediction unit 140 determines that any RAIM outages affect the requested flight plan, at step 3500, the RAIM outage prediction unit may generate one or more flight plan options based on the determined RAIM outages. The one or more generated flight plan options may be a change in departure time, destination, stopovers, route of flight, altitude, airspeed, etc., for example. The generated flight plan options may be presented in the form of a choice of complete flight plans, a choice of flight plan route changes, a choice of flight plan time changes, and a timeline showing times along the route of flight where RAIM outages will occur and will not occur so that at least one of the time and route of flight may be changed by the user, for example. The timeline may show a window of departure times when the user's route of flight will not be affected by RAIM outages, for example.

At step 3600, the RAIM outage prediction unit 140 may prompt the user to select at least one of the one or more generated flight plan options. At step 3700, the RAIM outage prediction unit 140 may receive the user's one or more selections.

At step 3800, a flight plan processing unit 140 may generate a modified flight plan based on the user's one or more selections. At step 3900, the flight plan processing unit 250 may output the modified flight plan to the user and store the modified flight plan in a flight plan database 295. The process may then go to step 3950 and end.

FIG. 4 is an exemplary flowchart illustrating one possible in-flight flight planning process using RAIM outage information in accordance with a possible embodiment of the disclosure. The in-flight flight planning process may occur anytime after the user has completed his or her flight plan, such as when on the ground (e.g., performing pre-flight duties, taxiing, etc.) or airborne.

At step 4100, the RAIM outage prediction unit 140 may obtain updated RAIM outage information. At step 4200, the RAIM outage prediction unit 140 may retrieve the user's flight plan from the flight plan database 295. At step 4300, the RAIM outage prediction unit 140 may compare the user's flight plan against the obtained updated RAIM outage information.

At step 4400, the RAIM outage prediction unit 140 may determine if any RAIM outages contained in the updated RAIM outage information affect the requested flight plan. If the RAIM outage prediction unit 140 determines that any updated RAIM outages do not affect the requested flight plan, the process may return to step 4100 where the RAIM outage prediction unit 140 may continue to monitor RAIM outage information and its affect on users' flight plans.

If at step 4400, the RAIM outage prediction unit 140 determines that any updated RAIM outages affect the requested flight plan, at step 4500 the RAIM outage prediction unit 140 may generate one or more flight plan options based on the determined RAIM outages. At step 4600, the RAIM outage prediction unit 140 may prompt the user to select at least one of the one or more generated flight plan options. At step 4700, the RAIM outage prediction unit 140 may receive the user's one or more selections.

At step 4800, the flight plain processing unit 250 may generate a modified flight plan based on the user's one or more selections. At step 4900, the flight plain processing unit 250 may output the modified flight plan to the user and store the modified flight plan in the flight plan database 295. The modified flight plan may be output to the user while in-flight by any known communication means, including radio, ACARS message, data link, electronic flight bag download, e-mail, computer, etc., for example. The process may then return to step 4100 where the RAIM outage prediction unit 140 may continue to monitor RAIM outage information and its affect on users' flight plans until the flight is complete.

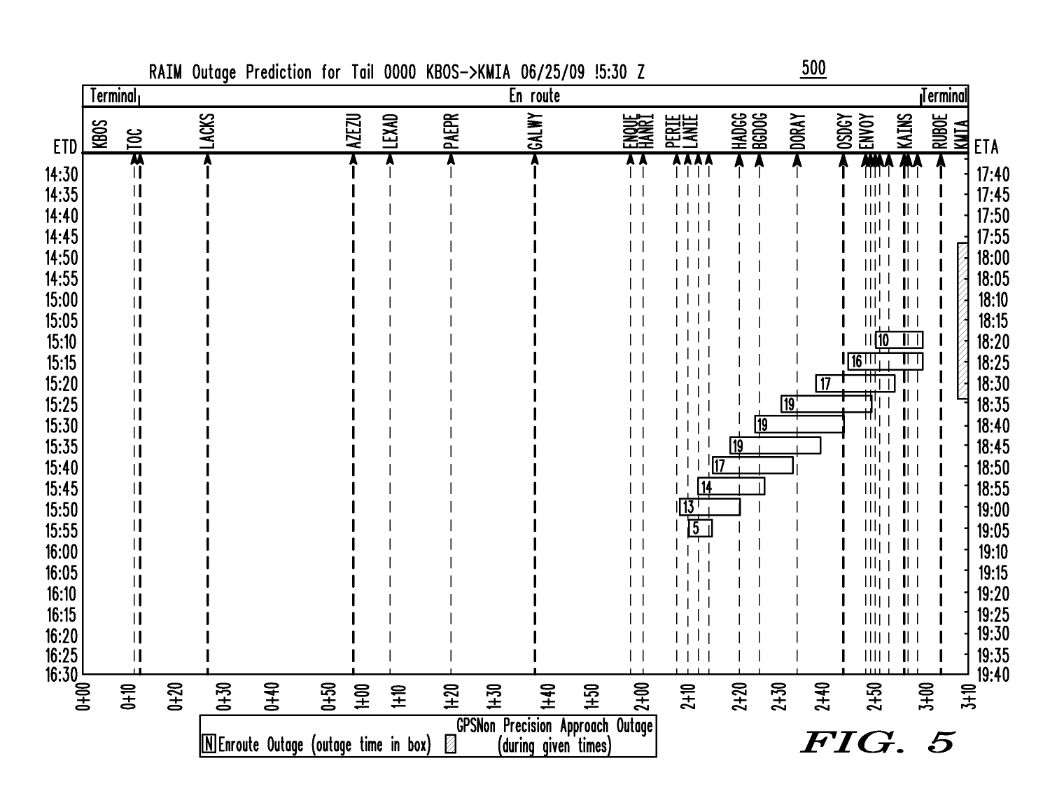

FIG. 5 is an illustration of RAIM outage information 500 and options concerning one possible aircraft flight plan in accordance with a possible embodiment of the disclosure. Exemplary RAIM outage information using the method of the disclose embodiments may include the flight plan origin, waypoints and destination are shown at the top, the clock time during flight is shown on the left, and the flight time is shown at the bottom. As shown, the location (via waypoint) of the GPS outages and the particular times of the outages may be shown as blocks in the center of the figure. The hatched block on the right may show the times when a GPS outage will affect a GPS non-precision approach, for example, which may typically have higher GPS accuracy requirements. As a result of this informational output and display that provides flight plan options, the pilot may adjust his or her flight plan inputs, such as departure time, arrival time, waypoints, airspeed, etc., to avoid the GPS outages.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosed embodiments are part of the scope of the disclosed embodiments. For example, the principles of the disclosed embodiments may be applied to each individual user where each user may individually deploy such a system. This enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A method for generating a flight plan for a user's aircraft using Receiver Autonomous Integrity Monitoring (RAIM) outage information, comprising:
receiving a flight plan request from the user, the flight plan request including at least aircraft identification information, aircraft type, true airspeed, departure point, departure time, cruising attitude, route of flight, destination, estimated time in-route, and fuel on board;
obtaining RAIM outage information, the RAIM outage information including at least predicted times and locations along a route of flight that an aircraft will lose accurate external navigation service coverage during a flight based on the requested flight plan;
comparing the requested flight plan against the obtained RAIM outage information;
determining if any RAIM outages contained in the RAIM outage information affect the requested flight plan, wherein if it is determined that any RAIM outages affect the requested flight plan,
generating one or more flight plan options based on the determined RAIM outages;
prompting the user to select at least one of the one or more generated flight plan options, the one or more generated flight plan options being at least one of a change in departure time, destination, stopovers, route of flight, altitude, and airspeed;
receiving the user's one or more selections;
generating a modified flight plan based on the user's one or more selections; and
outputting the modified flight plan to the user and storing the modified flight plan in a flight plan database.

2. The method of claim 1, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

3. The method of claim 2, wherein the timeline shows a window of departure times when the user's route of flight will not be affected by RAIM outages.

4. The method of claim 1, wherein if the user's aircraft is in-flight, further comprising:
obtaining updated RAIM outage information;
retrieving the user's flight plan from the flight plan database;
comparing the user's flight plan against the obtained updated RAIM outage information;
determining if any RAIM outages contained in the updated RAIM outage information affect the requested flight plan, wherein if it is determined that any updated RAIM outages affect the requested flight plan,
generating one or more flight plan options based on the determined RAIM outages;
prompting the user to select at least one of the one or more generated flight plan options;
receiving the user's one or more selections;
generating a modified flight plan based on the user's one or more selections; and
outputting the modified flight plan to the user.

5. The method of claim 4, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

6. The method of claim 1, wherein the RAIM outage information is obtained from one of a RAIM outage information database stored in memory and a safety of flight server.

7. The method of claim 1, wherein the method is performed by one of a server, a computer, a processing device, and a personal digital assistant.

8. A flight planning system that generates a flight plan for a user's aircraft using Receiver Autonomous Integrity Monitoring (RAIM) outage information, comprising:
a memory;
a flight plan database stored in the memory that stores flight plans; and
a RAIM outage prediction unit that receives a flight plan request from the user, obtains RAIM outage information, compares the requested flight plan against the obtained RAIM outage information, determines if any RAIM outages contained in the RAIM outage information affect the requested flight plan, wherein if the RAIM outage prediction unit determines that any RAIM outages affect the requested flight plan, the RAIM outage prediction unit generates one or more flight plan options based on the determined RAIM outages, prompts the user to select at least one of the one or more generated flight plan options, and receives the user's one or more selections; and
a flight plan processing unit that generates a modified flight plan based on the user's one or more selections, and outputs the modified flight plan to the user and stores the modified flight plan in a flight plan database,
wherein the flight plan request includes at least aircraft identification information, aircraft type, true airspeed, departure point, departure time, cruising attitude, route of flight, destination, estimated time in-route, and fuel on board, the RAIM outage information includes at least predicted times and locations along a route of flight that an aircraft will lose accurate external navigation service coverage during a flight based on the requested flight plan, and the one or more generated flight plan options are at least one of a change in departure time, destination, stopovers, route of flight, altitude, and airspeed.

9. The flight planning system of claim 1, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

10. The flight planning system of claim 9, wherein the timeline shows a window of departure times when the user's route of flight will not be affected by RAIM outages.

11. The flight planning system of claim 8, wherein if the user's aircraft is in-flight, the RAIM outage prediction unit obtains updated RAIM outage information, retrieves the user's flight plan from the flight plan database, compares the user's flight plan against the obtained updated RAIM outage information, determines if any RAIM outages contained in the updated RAIM outage information affect the requested flight plan, wherein if the RAIM outage prediction unit determines that any updated RAIM outages affect the requested flight plan, the RAIM outage prediction unit generates one or more flight plan options based on the determined RAIM outages, prompts the user to select at least one of the one or more generated flight plan options, and receives the user's one or more selections, and the flight plain processing unit generates a modified flight plan based on the user's one or more selections, and outputs the modified flight plan to the user.

12. The flight planning system of claim 11, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

13. The flight planning system of claim 8, wherein the RAIM outage information is obtained from one of a RAIM outage information database stored in memory and a safety of flight server.

14. The flight planning system of claim 1, wherein the flight planning system is one of a server, a computer, a processing device, and a personal digital assistant.

15. A computer-readable medium storing instructions for controlling a computing device for generating a flight plan for a user's aircraft using Receiver Autonomous Integrity Monitoring (RAIM) outage information, the instructions comprising:
receiving a flight plan request from the user, the flight plan request including at least aircraft identification information, aircraft type, true airspeed, departure point, departure time, cruising attitude, route of flight, destination, estimated time in-route, and fuel on board;
obtaining RAIM outage information, the RAIM outage information including at least predicted times and locations along a route of flight that an aircraft will lose accurate external navigation service coverage during a flight based on the requested flight plan;
comparing the requested flight plan against the obtained RAIM outage information;
determining if any RAIM outages contained in the RAIM outage information affect the requested flight plan, wherein if it is determined that any RAIM outages affect the requested flight plan,
generating one or more flight plan options based on the determined RAIM outages;
prompting the user to select at least one of the one or more generated flight plan options, the one or more generated flight plan options being at least one of a change in departure time, destination, stopovers, route of flight, altitude, and airspeed;
receiving the user's one or more selections;
generating a modified flight plan based on the user's one or more selections; and
outputting the modified flight plan to the user and storing the modified flight plan in a flight plan database.

16. The computer-readable medium of claim 15, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

17. The computer-readable medium of claim 16, wherein the timeline shows a window of departure times when the user's route of flight will not be affected by RAIM outages.

18. The computer-readable medium of claim 15, wherein if the user's aircraft is in-flight, further comprising:
obtaining updated RAIM outage information;
retrieving the user's flight plan from the flight plan database;
comparing the user's flight plan against the obtained updated RAIM outage information;
determining if any RAIM outages contained in the updated RAIM outage information affect the requested flight plan, wherein if it is determined that any updated RAIM outages affect the requested flight plan,
generating one or more flight plan options based on the determined RAIM outages;
prompting the user to select at least one of the one or more generated flight plan options;
receiving the user's one or more selections;
generating a modified flight plan based on the user's one or more selections; and
outputting the modified flight plan to the user.

19. The computer-readable medium of claim 18, wherein the generated flight plan options are in the form of one of at least one of a choice of complete flight plans, a choice of flight plan route changes, a choice of flight plan time changes, and a timeline showing times along the route of flight where RAIM outages will occur and will not occur so that at least one of the time and route of flight may be changed by the user.

20. The computer-readable medium of claim 15, wherein the RAIM outage information is obtained from one of a RAIM outage information database stored in memory and a safety of flight server.

21. The computer-readable medium of claim 15, wherein the computer-readable medium is coupled to a flight planning system, the flight planning system being one of a server, a computer, a processing device, and a personal digital assistant.
